(19) United States
(12) Patent Application Publication
(10) Pub. No.: US 2001/0023776 A1
(43) Pub. Date: Sep. 27, 2001

(54) Insulated wire and cable

(76) Inventor: Steven Zingheim, Palo Alto, CA (US)

Correspondence Address: TYCO ELECTRONICS CORPORATION, MAIL STOP R20/2B, 307 CONSTITUTION DRIVE, MENLO PARK, CA, 94025, US

(21) Appl. No.: 09/844,302

(22) Filed: Apr. 27, 2001

Related U.S. Application Data
(63) Continuation of application No. 08/224,358, filed on Apr. 7, 1994, now abandoned.

(51) Int. Cl. H02G 15/064

(52) U.S. Cl. 174/72 A

(57) ABSTRACT

Insulated wires which are particularly suitable for use in automatic transmissions are insulated by compositions containing a block copolymer in which one of the blocks is a crystalline polyvinylidene fluoride block and the other block is an amorphous block containing randomly copolymerized units derived from vinylidene fluoride and a comonomer, e.g. hexafluoropropylene.

### BACKGROUND OF THE INVENTION

1. Field of the Invention

This invention relates to insulated wires and cables.

2. Introduction to the Invention

It is well known to provide electrical insulation around wires and other conductors by means of a thermoplastic polymeric composition. There can be one or more insulating layers around a single conductor, and/or one or more insulating layers around a plurality of individually insulated conductors. The insulating compositions normally include a polymeric component and other ingredients such as fillers, antioxidants, stabilizers and fire retardants. A wide variety of polymers have been used for this purpose, but there remains a need for insulating compositions which will provide improved properties. Improvement is particularly desirable in insulated wires for use in automatic transmissions, e.g. in road vehicles powered by internal combustion engines. Such wires must provide extended service over a period of many years while immersed in automatic transmission fluid (often abbreviated to ATF) which, during operation of the vehicle, is heated to elevated temperatures, sometimes as high as 150° C. Furthermore, space is limited in automatic transmissions, so that the thinner the insulating layer, the better.

### SUMMARY OF THE INVENTION

I have discovered, in accordance with the present invention, that certain block copolymers derived from vinylidene fluoride and other comonomers are very suitable for use as wire insulation, especially on wires for use in automatic transmission systems and in other situations in which the insulated wire is exposed to high temperatures and/or to ATF's or liquids similar to ATFs. The block copolymers comprise (i) first polymeric blocks which comprise units derived from vinylidene fluoride and which are crystalline, and (ii) second polymeric blocks which comprise units derived from vinylidene fluoride and at least one comonomer, and which are substantially less crystalline than the first blocks and are preferably substantially amorphous. The first polymeric blocks preferably consist essentially of units derived from vinylidene fluoride, but may contains small amounts, preferably less than 5%, particularly less than 1%, of units derived from a comonomer (percentages are by weight through this specification). The second polymeric blocks comprise randomly copolymerized units derived from vinylidene fluoride and from at least one comonomer, preferably at least one other fluorinated comonomer.

The invention will chiefly be described herein by reference to insulated wires for use in automatic transmission systems in automobiles, trucks and other road and sea vehicles, in which the wires form part of circuits powered by batteries and/or by alternators, but it is to be understood that the invention includes also the use of the insulated wires in other automatic transmissions and the use of the block copolymers as electrical insulation on conductors of all types, especially but not exclusively when the insulation is continuously or intermittently contacted by an organic liquid, e.g. a mineral oil or other hydrocarbon, and/or operates at an elevated temperature, e.g. 100-150° C.

In a first preferred aspect, the invention provides an electrical harness which is suitable for use in an automatic transmission and which, when it is so used, is at least partially immersed in automatic transmission fluid, said harness comprising

(1) a plurality of electrical connectors, and

(2) a plurality of insulated wires, at least some of the insulated wires being physically and electrically connected to the connectors, and at least some of the insulated wires comprising (a) a wire and (b) an electrically insulating jacket which surrounds the wire and is being composed of an insulating polymeric composition comprising a polymeric component which comprises at least 50% by weight (based on the weight of the polymeric component) of a block copolymer which comprises

(i) first polymeric blocks in which at least 95% by weight of the repeating units are derived from vinylidene fluoride, and

(ii) second polymeric blocks in which at least 95% by weight of the repeating units are derived from vinylidene fluoride and at least one other fluorine-containing comonomer, and in which the repeating units are randomly copolymerized;

the ratio by weight of the units derived from vinylidene fluoride in the first blocks to the units derived from vinylidene fluoride in the second blocks being from 40:60 to 95:5, and the block copolymer containing 0.5 to 30% by weight of units derived from the other fluorine-containing comonomer.

Preferably, the insulating jacket is such that the insulated wires, after immersion in ATF at 150° C. for 2,000 hours, can be wrapped around a mandrel having a diameter twice the diameter of the insulated wire without cracking the insulation.

In a second preferred aspect, the invention provides apparatus which comprises

(1) a casing which is suitable for use as part of an automatic transmission and which contains an automatic transmission fluid when it is so used, and

(2) an insulated wire which is physically attached to the casing but electrically insulated therefrom at the point of physical attachment, and which, when the casing is in use as part of an automatic transmission and contains an automatic transmission fluid,

(a) is at least partially immersed in the automatic transmission fluid,

(b) forms part of an electrical circuit which is powered by direct current, and

(c) comprises a wire, and an electrically insulating jacket which surrounds the wire and is composed of an insulating polymeric composition as defined in the first aspect of the invention.

In a third preferred aspect, the invention provides an automatic transmission which is part of a road vehicle and which includes

(1) a casing which contains an automatic transmission fluid, and

(2) an insulated wire which

(a) is at least partially immersed in the automatic transmission fluid,

(b) forms part of an electrical circuit which is powered by a power source selected from batteries and alternators, and

(c) comprises a wire, and an electrically insulating jacket which surrounds the wire and is composed of an insulating polymeric composition as defined in the first aspect of the invention.

### BRIEF DESCRIPTION OF THE DRAWING

The invention is illustrated in the accompanying drawings, in which

FIGS. 1 and 2 are diagrammatic cross sections of insulated wires according to the invention, and

FIG. 3 is a diagrammatic sketch of an electrical harness for an automatic transmission and a casing for an automatic transmission in which the harness is placed.

### DETAILED DESCRIPTION OF THE INVENTION

In the block copolymers used in this invention, the ratio by weight of the units derived from vinylidene fluoride in the first blocks to the units derived from vinylidene fluoride in the second blocks is from 40:60 to 95:5, preferably 50:50 to 90:10, particularly 65:35 to 85:15, especially 70:30 to 80:20. The block copolymer contains 0.5 to 30%, preferably 1 to 20%, particularly 1 to 15%, especially 5 to 15%, of units derived from the comonomer, the percentages being by weight, based on the weight of the copolymer.

Those skilled in the art will have no difficulty, having regard to their own knowledge and the disclosure of this specification, in preparing block copolymers suitable for use in this invention. A preferred method of preparing suitable block copolymers comprises

(A) preparing a reactive oligomer corresponding to the first block by polymerizing a first monomer component which comprises at least 95% by weight vinylidene fluoride, and

(B) adding to the reaction mixture from step (1) a second monomer component which comprises vinylidene fluoride and at least one comonomer, and copolymerizing the second monomer component on the reactive oligomer, thus preparing the second block.

The polymerization steps (A) and (B) can be carried out by emulsion polymerization, or by suspension polymerization. For a detailed description of the preparation of suitable block copolymers by emulsion polymerization, reference may be made to U.S. Pat. No. 5,093,247 (Barber, assigned to Atochem North America Inc.), the entire disclosure of which is incorporated herein by reference. The copolymers prepared by that process are thermoplastics, with at least a majority, and usually substantially all, of the polymeric molecules consisting essentially of a single first block and a single second block. Such copolymers can of course be prepared by other processes. The copolymers used in this invention can also be thermoplastic elastomers, in which at least a majority, and preferably substantially all, of the polymeric molecules comprise at least one second block which is linked to at least two first blocks, thus providing a polymer which is an elastomer at temperatures below the melting point of the first blocks, and a thermoplastic above the melting point of the first blocks.

The melting point of the block copolymers used in this invention is preferably at least 160° C., particularly at least 163° C., and can be, for example 160-170° C. or even higher.

In the second blocks of the copolymer, the comonomer is preferably a fluorinated comonomer, particularly hexafluoropropylene (HFP). Other fluorinated comonomers which can be used, optionally in combination with HFP, include other fluoroalkenes, e.g. pentafluoropropylene, tetrafluoroethylene, and chlorotrifluoroethylene, fluoroalkoxyalkenes, e.g. perfluoroethoxyethylene, and fluoroalkylvinyl ethers, e.g. perfluoropropylvinyl ether, perfluoromethylvinyl ether, perfluoroethylvinyl ether and perfluorobutylvinyl ether.

One of the properties of the block copolymer which can have an important influence on the properties of the insulating jacket is its melt viscosity. In general, higher melt viscosities are preferred (though with a preferred maximum set by the desire for easy processability of the composition), with the preferred minimum being dependent in part on the amount and nature of other ingredients of the composition. The melt viscosity of the block copolymer is generally at least 5, preferably at least 10, particularly at least 15, especially at least 20, Kpoise, as measured by ASTM D 3835 at 232° C. and at a shear rate of 100 sec⁻¹.

The polymeric insulating compositions used in the present invention can contain other ingredients, in addition to the block copolymer, including other polymer and conventional ingredients such as fillers, antioxidants, stabilizers and fire retardants. The polymeric component of the composition contains at least 50% by weight of the block copolymer, based on the weight of the polymer component, and in general, the greater the percentage of the block copolymer, the better the properties of the insulation. Thus it may be preferred to use, preferably at least 60%, more preferably at least 70%, particularly at least 80%, more particularly at least 90%, especially substantially 100%, of the block copolymer. On the other hand, if an adequate performance can be obtained using a blend of the block copolymer with an additional, less expensive, polymer, it may be desirable to use such a blend. Additional polymers which may be present as part of the polymeric component, in amount, for example 10 to 45% by weight of the polymeric component, include other fluorinated polymers, e.g. homopolymers of vinylidene fluoride, which are preferred, homopolymers of one of the other fluorinated monomers referred to above, and random copolymers of two or more of vinylidene fluoride and such other fluorinated monomers. The block copolymer preferably constitutes at least 40%, preferably at least 60%, particularly at least 75%, by weight of the total composition.

Compositions comprising a blend of the block copolymer and a homopolymer of vinylidene fluoride are novel per se and form part of the present invention.

The insulating composition is preferably applied to the wire by melt extrusion. There may be a single layer of insulation which contains the block copolymer, or two or more layers of insulation in which only one of the layers contains the block copolymer, that layer being the innermost layer, an intermediate layer, or outermost layer. There may also be two or more layers of the same composition containing the block copolymer or two or more layers of different compositions containing the same block copolymer or different block copolymers. The thickness of the layer containing the block copolymer can vary widely, e.g. from 0.005 to 0.050 inch (0.127 to 1.27 mm) when the layer is the sole insulating layer, or from 0.001 to 0.050 inch (0.025 to 1.27 mm), preferably 0.002 to 0.01 inch (0.05 to 0.25 mm), when the layer is one of two or more layers. We have found that one of the surprising advantages of the invention is that a single layer which is only 0.006 to 0.015 inch, e.g. 0.007 to 0.010 inch (0.15 to 0.38 mm, e.g. 0.18 to 0.25 mm) thick can provide excellent results around a wire which is used in an automatic transmission system.

When the insulation around the wire includes a second layer of a different polymeric composition, the second layer can be of any kind which, in combination with the layer comprising the block copolymer provides the desired combination of physical properties. Even a very thin layer comprising the block copolymer, e.g. a layer about 0.003 inch (0.075 mm) thick, will substantially improve the performance of the wire when exposed to an ATF. We have obtained good results using a second layer which is 0.005 to 0.02 inch (0.127 to 0.5 mm), preferably 0.01 to 0.015 inch (0.25 to 0.4 mm), thick. The second layer may for example be composed of a composition which comprises at least one of the polymers described above as suitable additional polymers which may be blended with the block copolymer. Other suitable compositions are those described in copending, commonly assigned U.S. patent application Ser. No. 07/537,558 filed Jun. 13, 1990 (MP1360) and Ser. No. 08/004,749 filed Jan. 14, 1993 (MP1467) and in U.S. Pat. Nos. 2,167,278, 3,671,487, 3,835,089, 4,048,128 and 4,332,855, European Patent Publication No. 0,057,415. The entire disclosure of each of said applications, patents and patent publications is incorporated by reference herein for all purposes.

After the insulating composition comprising the block copolymer has been placed around the wire, the composition can if desired be crosslinked, thus improving its high temperature properties, especially at temperatures approaching its melting point. The copolymer is preferably crosslinked by irradiation, e.g. with high energy electrons to a dosage of, for example, 10 to 30 Mrads. If the composition is to be crosslinked by radiation, it preferably contains an ethylenically unsaturated radiation crosslinking agent, e.g. triallyl isocyanurate (TAIC) or triallyl cyanurate (TAC).

The wires which are used in this invention, especially those used in automatic transmission systems, are usually stranded wires, e.g. 16 to 24 AWG tin-coated copper wires. For an automatic transmission, the wires are usually prefabricated into a harness comprising a plurality of wires arranged in a configuration which is designed to fit a specific transmission system. The harness may lie completely within the casing of the transmission, the wires then being electrically connected to parts of the transmission which lie within the casing, e.g. to solenoids, or to connectors which are physically secured to the casing of the automatic transmission so that electrical connection can be made between the harness and the wiring system of the vehicle which lies outside the casing. Generally, one or more of the wires of the harness pass through the casing via a sealed port. Particularly in the latter case, there is a danger that any transmission fluid which penetrates the insulation will pass down the stranded wire and out of the casing. To reduce this danger, the stranded wire is preferably blocked by impregnating it with a suitable polymeric composition, e.g. a siloxane or a silicon rubber.

When the insulated wires are used in the automatic transmission system of a road vehicle (e.g. an automobile or a truck) they often form part of a circuit which is powered by direct current from a battery (or an alternator), typically a 12 volt (nominal) or 24 volt (nominal) battery. It is expected that higher voltages, e.g. up to 600 volts, may be used in the future in electrically powered vehicles. Surprisingly, I have found that the electrical performance of the insulated wires is much better when using DC than when using AC.

Compositions suitable for use as automatic transmission fluids (ATFs) are well known to those skilled in the art. Typically they are based on liquids which have low viscosity, e.g. less than 40 mm²/s at 40° C., and low viscosity-temperature dependence, and also contain numerous additives, e.g. friction modifiers, oxidation inhibitors and antiwear additives. Further information about ATFs is to be found in the SAE Information Report entitled Fluid for Passenger Car Type Automatic Transmissions—SAE J311 APR86 and the SAE Recommended Practice entitled Powershift Transmission Fluid Classification—SAE J1285 JAN85.

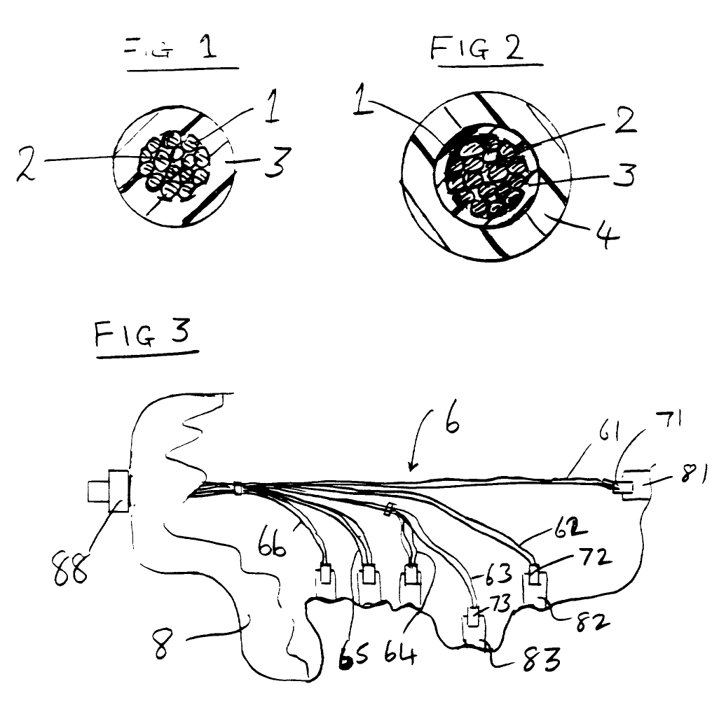

Referring now to the drawings, FIGS. 1 and 2 show an insulated wire comprising a stranded conductor 1 containing a blocking compound 2 and surrounded by a layer of insulation 3 containing a block copolymer as defined above and, in FIG. 2, a second layer of insulation 4 of a different polymeric composition. FIG. 3 shows an automatic transmission harness 6 which comprises a number of branches 61, 62 etc., each of which contains two or three insulated wires which terminate in terminals 71, 72 etc. which are plugged into receptacles 81, 82 etc. which are inside and secured to a transmission housing 8. The wires pass through the housing 8 via s sealed port 88.

### EXAMPLES

### Examples 1-5

Five insulating compositions were prepared. Each contained 88.8% of a polymer as specified in Table 1 below, 5% of antimony trioxide, 3.6% of triallyl isocyanurate, 0.1% of an antioxidant (available from Ciba Geigy under the trade name Irganox 1010) and 2.5% of dibasic lead phthalate (available from Anzon under the trade name Dythal XL). Each composition was melt extruded over a 13 AWG 37/29 tin-coated copper stranded wire to form an insulating jacket having a thickness of about 0.014 inch (0.35 mm). The jacket was then crosslinked by irradiating it to a dosage of about 15 Mrad. The insulation was removed from samples of the coated wires and subjected to the following tests.

Modulus

The M₁₀₀ value of the insulation, as first produced, was measured at 200° C., using the method set out in U.S. Pat. No. 4,155,823, the disclosure of which is incorporated herein by reference.

Initial Elongation

The elongation of the insulation, as first produced, was measured at room temperature, using the method set out in ASTM D 3032, Section 17, at a crosshead speed of 20 inch/min. and a jaw separation of 1.1 inch.

Annealed Elongation

The elongation of the insulation, after it had been heated to 200° C. by placing it in a preheated over and then cooled by allowing the oven to cool to room temperature over a period of about 3 hours, was measured at room temperature, using the same method as for the Initial Elongation.

Shrinkage

The insulation was heated to 155° C. and then cooled to room temperature. The shrinkage was measured.

The results of the testing are shown in Table 1 below.

The polymers used in Examples 1-5 are different grades of vinylidene fluoride polymer supplied by Atochem North America Inc. under the trade name Kynar. The polymers used in Examples 3 to 5 are block copolymers as used in this invention; the polymers used in Examples 1 and 2 are not. Table 1 below sets out the characteristics of these polymers and the results of testing the insulated wires made in Examples 1-5. Table 1 also shows the characteristics of another Kynar polymer which is used in Example 9 below and is also a block copolymer as used in this invention. The abbreviations VDF and HFP in Table 1 refer to vinylidene fluoride and hexafluoropropylene respectively. The melt viscosities in Table 1 are given in kilopoise and were measured by ASTM 3835 at 232° C. and a shear rate of 100 sec⁻¹.

### Examples 6-9

In Examples 6-9, an insulated wire as used in this invention was compared with insulated wires which have been used or proposed for use as insulation for automatic transmission wires. The insulated wires and the results of testing them are shown in Table 2 below. The following abbreviations are used in Table 2.

EF is a composition containing an elastomeric fluorocarbon polymer.

PES is a composition comprising a polyester alloy of the type disclosed in PCT (International) Application No. WO 93/08234 (E. I. du Pont de Nemours), the disclosure of which is incorporated herein by reference.

EAE is a composition comprising an ethylene/methacrylate elastomer sold by du Pont under the trade name Vamac.

Samples of the coated wires were tested for pinch resistance by the method of SAE J1128 and for scrape abrasion by the method of ISO 6722/1, using a 0.75 Kg load.

Further samples of the wire of Example 9 were tested for thermal stability. After aging in air at 250° C. for 168 hours, the insulation had an elongation of about 310% and a tensile strength of about 3,700 psi (260 kg/cm²), measured at room temperature by the method of ASTM D 3032 at a crosshead speed of 20 inch/min. and a jaw separation of 1.1 inch.

Further samples of the wire of Example 9 were tested for voltage withstand at 150° C. Application of an AC voltage of 250 volts RMS resulted in failure of the insulation. Application of a DC voltage of 40 volts did not cause failure, at 150° C. or even at 200° C. Voltage withstand was measured by the procedure of UL Subject 758.

Further samples of the wire of Example 9 were tested for resistance to hot HTF. After immersion for 7,000 hours in a commercial ATF (the product sold by Exxon under the trade name H-FN1975) at 150° C., the insulation had not swollen, and did not crack when the insulated wire was wrapped several times around a mandrel having twice the diameter as the insulated wire. After immersion for 24 hours in the same ATF at 170° C., the insulation had not swollen, and did not crack when the insulated wire was wrapped several times around a c mandrel having a diameter twice the diameter of the insulated wire. After immersion for 4,000 hours in another commercial ATF (the product sold by Ethyl Petroleum Additives Inc. under the trade name Dexron III) at 150° C., the insulation had not swollen, and did not crack when the insulated wire was wrapped several times around a mandrel having a diameter twice the diameter of the insulated wire.

TABLE 1

| Example No. | 1 | 2 | 3 | 4 | 5 | 9 |
|---|---|---|---|---|---|---|
| Polymer | | | | | | |
| Grade | 460 | 2800 | RC10051 | RC10053 | RC10054 | RC10089 |
| Monomers | | | | | | |
| VDF % | 100 | 88 | 90 | 95 | 90 | 90 |
| HFP % | 0 | 12 | 10 | 5 | 10 | 10 |
| Properties | | | | | | |
| Melting Point ° C. | 160 | 144 | 165 | 165 | 165 | 168 |
| Melt Viscosity (Kp) | 26 | 23 | 3.4 | 9.1 | 19.5 | 20.4 |
| Test Results | | | | | | |
| M₁₀₀ (psi) | ≅80 | 135 | 80 | 50 | 110 | |
| Shrinkage % | 0 | 4.5 | 0 | 1 | 0 | |
| Initial Elong'n % | ≅300 | 365 | 40 | 20 | 330 | |
| Annealed Elong'n % | ≅50 | ≅330 | — | — | ≅310 | |
| Initial Necks | 0/5 | 0/5 | 5/5 | 4/4 | 0/5 | |
| Annealed Necks | 5/5 | 0/5 | — | — | 0/5 | |

TABLE 2

| Example No. | 6 | 7 | 8 | 9 |
|---|---|---|---|---|
| Wire Size (AWG) (Stranding) | 20 (7/28) | 20 (7/28) | 18 (16/30) | 20 (19/30) |
| Jacket | | | | |
| Material | EF | PES | EAE | RC10089 |
| Wall thickness (mil) | 16 | 16 | 37 | 8 |
| Properties | | | | |
| Pinch Resistance (lb) | 4.8 | 15.7 | 28.8 | 22.3 |
| Scrape Abrasion (cycles) | 106 | 625 | 316 | 95 |

I claim:

1. An electrical harness which is suitable for use in an automatic transmission and which, when it is so used, is at least partially immersed in automatic transmission fluid;
said harness comprising
(1) a plurality of electrical connectors, and
(2) a plurality of insulated wires, at least some of the insulated wires being physically and electrically connected to the connectors, and at least some of the insulated wires comprising (a) a wire, and (b) an electrically insulating jacket which surrounds the wire and is composed of an insulating polymeric composition comprising a polymeric component which comprises at least 50% by weight, based on the weight of the polymeric component, of a block copolymer which comprises
(i) first polymeric blocks in which at least 95% by weight of the repeating units are derived from vinylidene fluoride, and
(ii) second polymeric blocks in which at least 95% by weight of the repeating units are derived from vinylidene fluoride and at least one other fluorine-containing comonomer, and in which the repeating units are randomly copolymerize;
the ratio by weight of the units derived from vinylidene fluoride in the first blocks to the units derived from vinylidene fluoride in the second blocks being from 40:60 to 95:5, and the block copolymer containing 0.5 to 30% by weight of units derived from the other fluorine-containing comonomer.

2. A harness according to claim 1 wherein the polymeric component consists essentially of the block copolymer, and the block copolymer consists essentially of said first and second polymeric blocks.

3. A harness according to claim 1 wherein the block copolymer has been prepared by a process which comprises
(A) preparing a reactive oligomer corresponding to the first blocks by polymerizing a first monomer component which comprises at least 95% by weight vinylidene fluoride, and
(B) adding to the reaction mixture from step (1) a second monomer component which comprises vinylidene fluoride and at least one fluorine-containing comonomer, and copolymerizing the second monomer component on the reactive oligomer, thereby preparing the block copolymer.

4. A harness according to claim 3 wherein the polymerization steps (A) and (B) are carried out by emulsion polymerization.

5. A harness according to claim 3 wherein the polymerization steps (A) and (B) are carried out by suspension polymerization.

6. A harness according to claim 1 wherein the block copolymer has a melting point of at least 160° C.

7. A harness according to claim 1 wherein (a) the first blocks consist essentially of units derived from vinylidene fluoride and (b) the other fluorine-containing monomer in the second polymeric blocks is at least one monomer selected from the group consisting of fluoroalkenes, fluoroalkoxyalkenes, and fluoroalkylvinyl ethers.

8. A harness according to claim 1 wherein the other fluorine-containing monomer in the second polymeric blocks is at least one monomer selected from the group consisting of hexafluoropropylene, tetrafluoroethylene, chlorotrifluoroethylene, perfluoroethoxyethylene, perfluoropropylvinyl ether, perfluoromethylvinyl ether, perfluoroethylvinyl ether and perfluorobutylvinyl ether.

9. A harness according to claim 1 wherein (a) the first blocks consist essentially of units derived from polyvinylidene fluoride and (b) the other fluorine-containing monomer in the second polymeric blocks consists essentially of hexafluoropropylene, and the block copolymer contains 5 to 15% by weight of units derived from hexafluoropropylene.

10. A harness according to claim 1 wherein said insulating jacket is the only insulating jacket around at least some of the wires, and the thickness of the insulating jacket is 0.005 to 0.025 inch.

11. A harness according to claim 1 wherein said insulating jacket contacts the conductor and is 0.002 to 0.005 inch thick, and is surrounded by a second insulating jacket which is 0.008 to 0.020 inch thick.

12. A harness according to claim 1 wherein at least one of the wires is a stranded wire containing a blocking compound between the strands of the wire.

13. A harness according to claim 1 wherein the polymeric composition contains at least 75% by weight, based on the weight of the composition, of the block copolymer.

14. An electrical harness which is suitable for use in an automatic transmission in an automobile and which, when it is so used, is at least partially immersed in automatic transmission fluid and forms part of an electrical circuit which is powered by a battery;
said harness comprising
(1) a plurality of electrical connectors, and
(2) a plurality of insulated wires, at least some of the insulated wires being physically and electrically connected to the connectors, and each of the insulated wires comprising (a) a stranded wire and (b) an electrically insulating jacket which surrounds the wire and is composed of an insulating polymeric composition comprising at least 50% by weight, based on the weight of the composition, of a block copolymer which consists essentially of
(i) first polymeric blocks which consist essentially of repeating units derived from vinylidene fluoride, and
(ii) second polymeric blocks which consist essentially of repeating units derived from vinylidene fluoride and from at least one other fluorine-containing comonomer selected from hexafluoropropylene, tetrafluoroethylene, and chlorotrifluoroethylene, and in which the repeating units are randomly copolymerized;
the ratio by weight of the units derived from vinylidene fluoride in the first blocks to the units derived from vinylidene fluoride in the second blocks being from 65:35 to 85:15, and the block copolymer containing 5 to 15% by weight of units derived from the other fluorine-containing comonomer.

15. A harness according to claim 14 wherein said insulating jacket is the sole insulation around each of the wires and is 0.006 to 0.015 inch thick.

16. A harness according to claim 15 wherein the block copolymer is crosslinked.

17. Apparatus which comprises
(1) a casing which is suitable for use as part of an automatic transmission and which contains an automatic transmission fluid when it is so used, and
(2) an insulated wire which is physically attached to the casing but electrically insulated therefrom at the point of physical attachment, and which, when the casing is in use as part of an automatic transmission and contains an automatic transmission fluid,
(a) is at least partially immersed in the automatic transmission fluid,
(b) forms part of an electrical circuit which is powered by direct current, and
(c) comprises a wire, and an electrically insulating jacket which surrounds the wire and is composed of an insulating polymeric composition comprising a polymeric component which comprises at least 50% by weight, based on the weight of the polymeric component, of a block copolymer which comprises
(i) first polymeric blocks in which at least 95% by weight of the repeating units are derived from vinylidene fluoride, and
(ii) second polymeric blocks in which at least 95% by weight of the repeating units are derived from vinylidene fluoride and at least one other fluorine-containing comonomer, and in which the repeating units are randomly copolymerized;
the ratio by weight of the units derived from vinylidene fluoride in the first blocks to the units derived from vinylidene fluoride in the second blocks being from 40:60 to 95:5, and the block copolymer containing 0.5 to 30% by weight of units derived from the other fluorine-containing comonomer.

18. Apparatus according to claim 17 wherein the insulating polymeric composition contains at least 80% by weight of the block copolymer; the block copolymer consists essentially of said first and second polymeric blocks and has a melting point of at least 163° C.; the first blocks consist essentially of units derived from vinylidene fluoride, and the second blocks consist essentially of units derived from vinylidene fluoride and another fluorine-containing monomer selected from the group consisting of hexafluoropropylene, tetrafluoroethylene, and chlorotrifluoroethylene; the ratio by weight of the units derived from vinylidene fluoride in the first blocks to the units derived from vinylidene fluoride in the second blocks is from 70:30 to 80:20, and the block copolymer contains 5 to 15% by weight of units derived from the other fluorine-containing comonomer.

19. Apparatus according to claim 18 wherein said insulating jacket is the only insulating jacket around the wire and is 0.006 to 0.015 inch thick.

20. An automatic transmission which is part of a road vehicle and which includes
(1) a casing which contains an automatic transmission fluid, and
(2) an insulated wire which
(a) is at least partially immersed in the automatic transmission fluid,
(b) forms part of an electrical circuit which is powered by a battery, and
(c) comprises a wire, and an electrically insulating jacket which surrounds the wire and is contacted by the transmission fluid, the insulating jacket being composed of an insulating polymeric composition comprising a polymeric component which comprises at least 50% by weight, based on the weight of the polymeric component, of a block copolymer which comprises
(i) first polymeric blocks in which at least 95% by weight of the repeating units are derived from vinylidene fluoride, and
(ii) second polymeric blocks in which at least 95% by weight of the repeating units are derived from vinylidene fluoride and at least one other fluorine-containing comonomer, and in which the repeating units are randomly copolymerized;
the ratio by weight of the units derived from vinylidene fluoride in the first blocks to the units derived from vinylidene fluoride in the second blocks being from 40:60 to 95:5, and the block copolymer containing 0.5 to 30% by weight of units derived from the other fluorine-containing comonomer.
